(19) United States
(12) Patent Application Publication
(10) Pub. No.: US 2013/0173077 A1
(43) Pub. Date: Jul. 4, 2013

(54) POWER SWITCH HAVING SERIES-CONNECTED SWITCHING STAGES

(71) Applicants: Zu Xun Ye, Shanghai (CN); Joseph Gerard Garofalo, Palo Alto, CA (US); Ming Chen, Shanghai (CN); ChunXuan Pei, Shanghai (CN); Xiaopeng Xie, Shanghai (CN)

(72) Inventors: Zu Xun Ye, Shanghai (CN); Joseph Gerard Garofalo, Palo Alto, CA (US); Ming Chen, Shanghai (CN); ChunXuan Pei, Shanghai (CN); Xiaopeng Xie, Shanghai (CN)

(73) Assignee: LSI Corporation, Milpitas, CA (US)

(21) Appl. No.: 13/339,790

(22) Filed: Dec. 29, 2011

(51) Int. Cl. G05F 5/00; H01H 47/00

(52) U.S. Cl. 700/295; 307/113

(57) ABSTRACT

A power switch of a processing device comprises a plurality of series-connected switching stages, with each switching stage comprising a plurality of parallel-connected switching devices and an inverter chain. The switching devices are coupled between a power supply input and a power supply output of the power switch. Each of the switching devices of a given one of the switching stages is driven by an output of a corresponding one of the inverters of the inverter chain of that stage. A control input of the first switching stage receives a control signal for controlling a state of the power switch, and a control input of each remaining switching stage is driven by a control output of an immediately preceding switching stage. The switching devices in one or more of the switching stages are configured to have different switching characteristics than the switching devices in at least one other stage.

### BACKGROUND

Integrated circuits often include multiple distinct circuit cores that are designed to perform particular functions. Integrated circuits of this type include system-on-chip (SOC) integrated circuits. By way of example, an SOC integrated circuit may be incorporated into a disk-based storage device such as a hard disk drive (HDD) that is used to provide non-volatile data storage in a data processing system. The SOC integrated circuit of an HDD is typically configured to process data from a computer or other processing device into a suitable form to be written to a magnetic storage disk, and to transform signal waveforms read from the storage disk into data for delivery to the processing device. Examples of circuit cores of an HDD SOC may include disk controller and read channel cores.

In order to conserve power in a processing device that includes an SOC, it is common for one or more of the various circuit cores of the SOC to be placed into a sleep mode or otherwise turned off when not in use. Turning on and off a given circuit core of an SOC will generally involve connecting and disconnecting a power supply voltage to that circuit core via a power switch.

The SOC has extensive digital circuitry and therefore has typically used advanced CMOS process technologies to meet cost and performance objectives. In a deep sub-micron CMOS process, such as a 40 nanometer (nm) process, static leakage current through a circuit core that is not actively operating but is not turned off can be substantial. Although this static leakage current through the circuit core can be significantly reduced by turning off the circuit core via a power switch, turning the circuit core on and off can create additional issues in terms of inrush current and voltage disturbances on the power supply lines, which can cause other actively operating circuit cores of the SOC to malfunction.

### SUMMARY

Illustrative embodiments of the invention provide improved power switches that are better able to control inrush current and supply line voltage disturbance than conventional power switches. Such switches are therefore able to turn on and off a given circuit core of an SOC or other integrated circuit without interfering with the operation of other circuit cores of that integrated circuit. The power switches are well suited for use in power supply circuitry that may be part of an SOC in a disk-based storage device such as an HDD, or part of another type of processing device.

In one embodiment, a power switch that may be incorporated into power supply circuitry of a storage device or other type of processing device comprises a plurality of series-connected switching stages, with each series-connected switching stage comprising a plurality of parallel-connected switching devices and an inverter chain. The parallel-connected switching devices are coupled between a power supply input and a power supply output of the power switch. Each of the parallel-connected switching devices of a given one of the series-connected switching stages is driven by an output of a corresponding one of the inverters of the inverter chain of that switching stage. An input of a first one of the switching stages is adapted to receive a control signal for controlling a state of the power switch, and an input of each of the remaining switching stages is driven by an output of an immediately preceding one of the switching stages. The parallel-connected switching devices in one or more of the switching stages are configured to have different switching characteristics than the parallel-connected switching devices in at least one other one of the switching stages.

By way of example, the parallel-connected switching devices in one of the switching stages may have different threshold voltages or on resistances than the parallel-connected switching devices of another one of the switching stages.

One or more of the illustrative embodiments can provide significantly enhanced performance in disk-based storage devices or other processing devices that incorporate integrated circuit power switches. For example, different circuit cores of the integrated circuit can be readily turned on and off in order to conserve device power without undue concern regarding adverse impacts of inrush current and voltage disturbances on other actively operating circuit cores of the integrated circuit. Embodiments of the invention can be configured to control both power up and power down transient currents while maintaining a low voltage drop across the power switch under high current load conditions.

### BRIEF DESCRIPTION OF THE DRAWINGS

FIG. 1 is a block diagram of a data processing system comprising a plurality of processing devices with at least one such processing device comprising a processor integrated circuit having power supply circuitry in an illustrative embodiment.

FIG. 2 shows a more detailed view of portions of the processing device power supply circuitry of FIG. 1 in an illustrative embodiment.

FIG. 3 is a schematic diagram of a power switch of the power supply circuitry of FIG. 2.

FIG. 4 is a block diagram of a data processing system comprising a storage device having multiple power switches of the type shown in FIG. 3 for controlling application of power to respective circuit cores in an illustrative embodiment.

FIG. 5 shows a portion of a power switch in another embodiment.

### DETAILED DESCRIPTION OF THE INVENTION

Embodiments of the invention will be illustrated herein in conjunction with exemplary data processing systems and associated power supply circuitry comprising power switches configured to control application of power supply voltages to respective circuit cores of an integrated circuit. It should be understood, however, that embodiments of the invention are more generally applicable to any integrated circuit power switching application.

FIG. 1 shows an embodiment of the invention in which a data processing system 100 comprises a plurality of processing devices 102-1, 102-2, . . . 102-R that communicate over a network 104. Processing device 102-1 is shown in greater detail as comprising a processor integrated circuit 110, a memory 112 and a network interface 114, and one or more of the remaining processing devices 102-2 through 102-R may each be assumed to be configured in a similar manner. The processor integrated circuit 110 is coupled to the memory 112 and the network interface 114, and further comprises power supply circuitry 120 that includes a plurality of power switches 122. The power switches 122 are associated with respective ones of a plurality of circuit cores 124 of the processor integrated circuit 110. The circuit cores may comprise, for example, different computational cores of the processor integrated circuit 110, such as different arithmetic logic unit (ALU) or central processing unit (CPU) cores, or other types of functional cores, in any combination.

Certain operations of the power supply circuitry 120 may be performed under the control of software executed by the processor integrated circuit 110. For example, a controller of the processor integrated circuit may be configured to execute code stored in the memory 112 for performing operations that involve turning on and off particular ones of the circuit cores 124 via the power switches 122. Thus, at least a portion of the power switch control functionality of the processor integrated circuit 110 may be implemented at least in part in the form of software code stored in memory 112. The memory 112 may comprise electronic memory such as random access memory (RAM) or read-only memory (ROM), as well as other types of storage media, in any combination. The memory 112 may be viewed as one example of what is more generally referred to herein as a computer-readable storage medium, or still more generally, a computer program product.

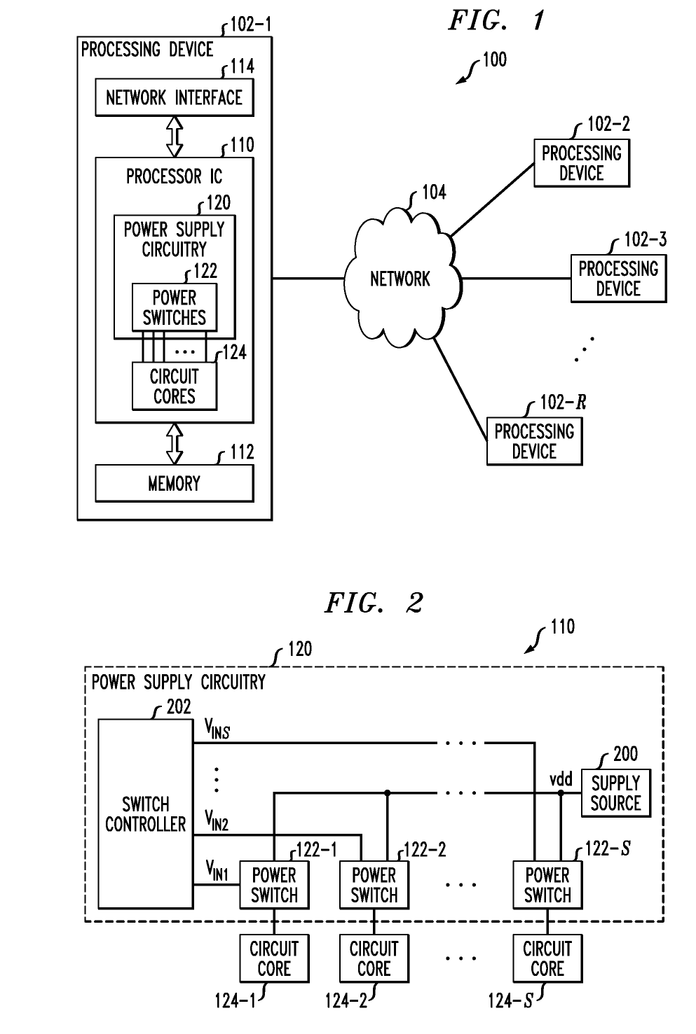

Referring now to FIG. 2, a more detailed view of processor integrated circuit components 120, 122 and 124 is shown. In this embodiment, the power supply circuitry 120 comprises S power switches denoted 122-1, 122-2, . . . 122-S, with each such power switch controlling application of a vdd power supply voltage from a supply source 200 to a corresponding one of S circuit cores denoted 124-1, 124-2, . . . 124-S. Each of the power switches 122 has a power supply input for receiving the vdd power supply voltage from the supply source 200, a power supply output for providing the vdd power supply voltage to a vdd supply voltage input of the corresponding one of the circuit cores 124, and a control input adapted to receive a control signal for controlling a state of the power switch. The control signals applied to the control inputs of power switches 122-1, 122-2, . . . 122-S are denoted V_{IN1}, V_{IN2}, . . . V_{INS}, respectively, and are generated by a switch controller 202.

The power switches 122 in the present embodiment have only two states, namely, an on state in which the vdd power supply voltage is applied to the corresponding circuit core 124, and an off state in which the vdd power supply voltage is not applied to the corresponding circuit core 124. The state of a given power switch is controlled by the logic level of its corresponding control signal V_{IN}. It should be understood, however, that other embodiments may have more than two states for each power switch.

The switch controller 202 may be configured to generate the control signals V_{IN} so as to turn on and turn off the various circuit cores 124 as needed. For example, the switch controller 202 may turn off a particular circuit core if it detects that the circuit core has not been actively operating for a designated period of time, and may turn that circuit core back on responsive to an interrupt directed to the circuit core or other indication that the circuit core will be entering an active mode of operation. Thus, the switch controller 202 can be configured to control entry and exit of the circuit cores 124 from respective sleep modes of operation, or other types of transitions of the circuit cores between active and inactive modes of operation, by controlling the logic levels of the associated control signals.

Elements 122, 124, 200 and 202 as arranged in FIG. 2 may be viewed as collectively comprising one possible example of “power supply circuitry” as that term is used herein.

Numerous alternative arrangements of power supply circuitry comprising one or more power switches may be used in other embodiments, and such arrangements may include only a subset of the components 122, 124, 200 and 202, or portions of one or more of these components. For example, power supply circuitry may but need not encompass at least a portion of the supply source 200. It should be noted in this regard that the supply source, or portions thereof, may be located external to the processor integrated circuit 110. The term “power supply circuitry” as used herein is therefore intended to be broadly construed, and may but need not include a supply source.

The particular configurations of data processing system 100 as shown in FIG. 1 and its power supply circuitry 120 as shown in FIG. 2 are exemplary only, and the system 100 and power supply circuitry 120 in other embodiments may include other elements in addition to or in place of those specifically shown, including one or more elements of a type commonly found in a conventional implementation. For example, the processor integrated circuit 110 may comprise, by way of illustration only and without limitation, a microprocessor, a digital signal processor, an application-specific integrated circuit (ASIC), a field-programmable gate array (FPGA), or other type of data processing device, as well as portions or combinations of these and other devices, adapted to incorporate at least one power switch 120 for controlling application of power to at least one circuit core or other functional block.

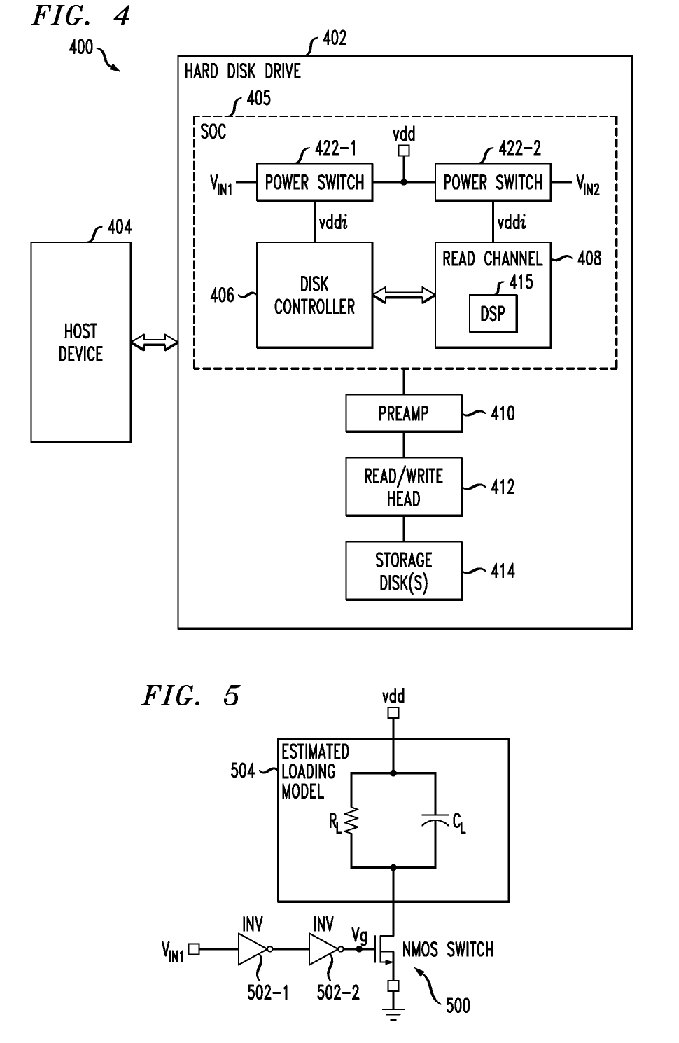

Also, it is to be appreciated that the power supply circuitry 120 comprising one or more power switches 122 and possibly an associated switch controller can be implemented in a wide variety of different types of data processing systems. Another embodiment of such a system, comprising a data storage device that incorporates a pair of power switches 120 for controlling application of power to respective disk controller and read channel cores of an HDD SOC, will be described in greater detail below in conjunction with FIG. 4. In a given embodiment, at least a portion of the switch controller may be incorporated into at least one of the power switches itself, such that a separate controller is not utilized.

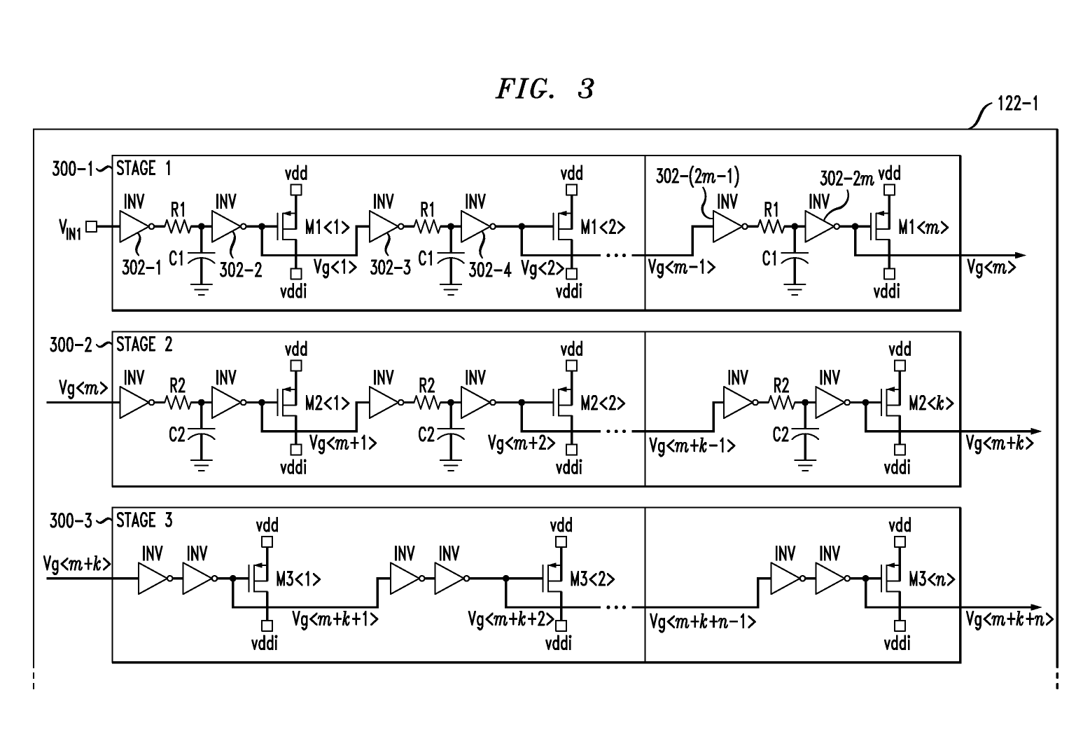

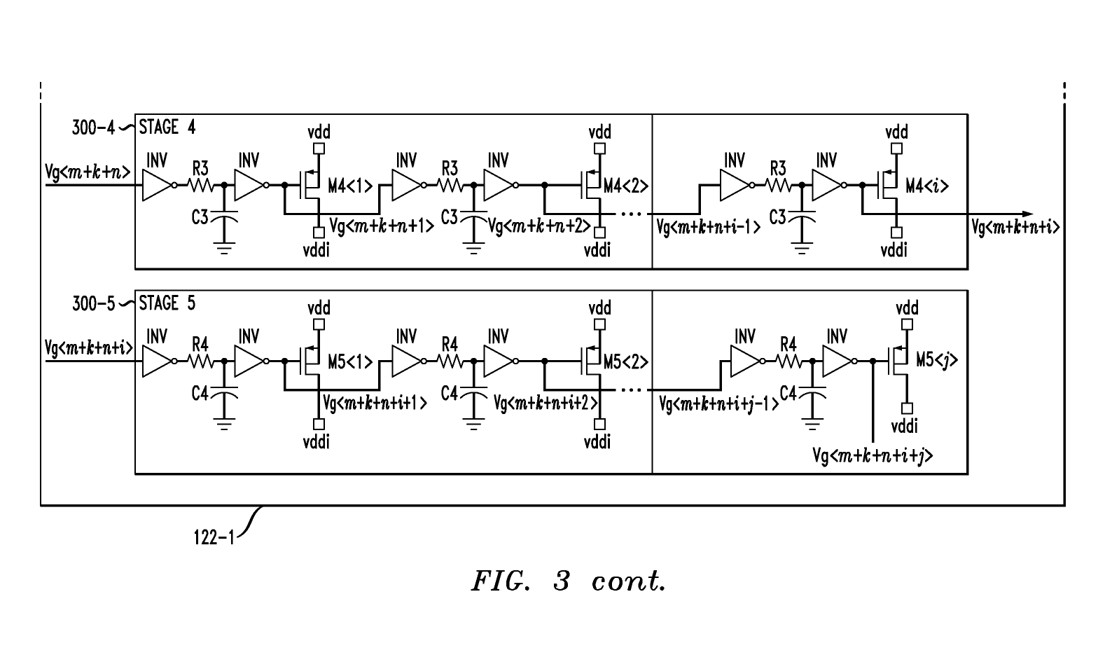

FIG. 3 shows an embodiment of a particular one of the power switches 122-1 in more detail. Although only a single power switch is shown in this figure, one or more of the other power switches 122 may be assumed to be configured in a similar manner. As shown, the power switch 122-1 comprises a plurality of series-connected switching stages 300-1, 300-2, 300-3, 300-4 and 300-5, also denoted herein as Stage 1 through Stage 5, respectively. A control input of the first one of the switching stages 300-1 is adapted to receive the control signal V_{IN1} for controlling the state of the power switch 122-1. A control input of each of the remaining switching stages 300-2 through 300-5 is driven by a control output of an immediately preceding one of the switching stages.

Each of the five series-connected switching stages 300-l, l=1, 2, . . . 5, comprises a plurality of parallel-connected switching devices Ml and an inverter chain that comprises two inverters 302 for each of the switching devices. The parallel-connected switching devices are coupled in parallel with one another between a power supply input and a power supply output of the power switch 122-1. The power supply input and power supply output of the power switch 122-1 are denoted in this embodiment as vdd and vddi, respectively, but different inputs and outputs may be used in other embodiments.

The parallel-connected switching devices in the switching stages 300 are implemented as respective metal-oxide-semiconductor (MOS) transistors, and more particularly as p-type MOS (PMOS) transistors, although other types of switching devices can be used in other embodiments. Each PMOS transistor has its source terminal coupled to a power supply input of the power switch 122-1 and its drain terminal coupled to a power supply output of the power switch 122-1. The power supply input of the power switch 122-1 in this embodiment is the supply voltage vdd. The power supply output of the power switch 122-1 is denoted vddi and corresponds to a power supply input of the circuit core 124-1 that is associated with the power switch 122-1. The gate terminal of each of the transistors Mi is coupled to an output of a corresponding one of the inverters 302 of the inverter chain of the corresponding switching stage 300-i.

As will be described in greater detail below, the parallel-connected switching devices Mi are configured to have different switching characteristics depending upon the placement of their corresponding switching stage 300-l in the series connection of switching stages of the power switch 122-1. These switching characteristics may comprise threshold voltage and on resistance, and may vary from switching stage to switching stage.

Thus, for example, the two initial switching stages 300-1 and 300-2 of the five switching stages in the FIG. 3 embodiment are primarily configured to control a rate of change of power supply current when the power switch 122-1 is transitioning from an off state to an on state, and the two final switching stages 300-4 and 300-5 are primarily configured to control the rate of change of power supply current when the power switch 122-1 is transitioning from the on state to the off state.

As a more particular example, the on resistance of the switching devices may be reduced from switching stage to switching stage in the initial switching stages used to control the rate of change of power supply current when the power switch is transitioning from the off state to the on state, and the on resistance of the switching devices may be increased from switching stage to switching stage in the final switching stages used to control the rate of change of power supply current when the power switch is transitioning from the on state to the off state.

The switching stages 300 may each include different numbers of switching devices Ml. As shown in the figure, Stage 1 comprises m switching devices denoted M1<1> through M1<m>, Stage 2 comprises k switching devices denoted M2<1> through M2<k>, Stage 3 comprises n switching devices denoted M3<1> through M3<n>, Stage 4 comprises i switching devices denoted M4<1> through M4<i>, and Stage 5 comprises j switching devices denoted M5<1> through M5<j>. Accordingly, in this embodiment the power switch 122-1 comprises m+k+n+i+j switching devices, with at least a subset of the variables m, k, n, i and j not having the same value, such that at least two of the switching stages 300 comprise different numbers of parallel-connected switching devices.

By way of example, one of the switching stages may have at least 10 times more parallel-connected switching devices than one or more of the other switching stages. In the present embodiment, each of the two initial switching stages 300-1 and 300-2 and the two final switching stages 300-4 and 300-5 may have substantially fewer parallel-connected switching devices than the remaining switching stage 300-3 located between the two initial and two final switching stages. For example, the initial and final switching stages may each comprise less than 100 parallel-connected switching devices, with the remaining switching stage comprising more than 1000 parallel-connected switching devices.

Of course, other numbers and arrangements of switching devices distributed across the various series-connected switching stages of the power switch may be used in other embodiments. A more specific example will be shown and described in conjunction with TABLE 1 below.

The switching stages 300-1 through 300-5 in the FIG. 3 embodiment are connected in series by connecting a control output signal vg<m> of the first stage 300-1 to an input of the first inverter of the inverter chain of the second stage 300-2, a control output signal vg<m+k> of the second stage 300-2 to an input of the first inverter of the inverter chain of the third stage 300-3, a control output signal vg<m+k+n> of the third stage 300-3 to an input of the first inverter of the inverter chain of the fourth stage 300-4, and a control output signal vg<m+k+n+i> of the fourth stage 300-4 to an input of the first inverter of the inverter chain of the fifth stage 300-5. The control output signals vg of the stages 300-1 through 300-5 correspond to the respective gate voltages of the final switching devices M1<m>, M2<k>, M3<n>, M4<i> and M5<j> of those stages.

As indicated previously, the inverter chain within each switching stage 300-l comprises a set of two series-connected inverters for each of the parallel-connected switching devices Ml of that stage. Thus, for example, in Stage 1, the corresponding control signal V_{IN1} is applied to an input of a first inverter 302-1 of the first set of two series-connected inverters. The output of the first inverter 302-1 drives an input of a second inverter 302-2 of the first set of two series-connected inverters. The output of the second inverter 302-2 is applied to a gate terminal of the first switching device M1<1>. The gate terminal is an example of what is more generally referred to herein as a “control terminal” of a switching device. This arrangement continues throughout the switching stage, with the final switching device M1<m> being associated with a final set of two series-connected inverters 302-(2m−1) and 302-2m, and with an output of the second inverter 302-2m being coupled to the gate terminal of the final switching device M1<m>. The other switching stages have their inverter chains and switching devices configured in a similar manner.

In each of the two initial switching stages 300-1 and 300-2 and the two final switching stages 300-4 and 300-5, resistor-capacitor (RC) circuits are coupled between the first and second series-connected inverters in respective ones of the sets of inverters of the inverter chains. Thus, for example, in Stage 1, RC circuits comprising a series resistor R1 and a parallel capacitor C1 are arranged between the first and second series-connected inverters of each set of two inverters associated with a given one of the switching devices. More particularly, a given one of the RC circuits of Stage 1 in this embodiment comprises a resistor R1 connected in series between an output of the first inverter 302-1 and an input of the second inverter 302-2, and a capacitor C1 connected between the input of the second inverter 302-2 and a lower supply potential, in this case illustratively shown as ground potential. Stages 2, 4 and 5 include similar RC circuit arrangements between the inverters of each set of series-connected inverters of their respective inverter chains, using resistor-capacitor pairs that are denoted R2-C2, R3-C3 and R4-C4, respectively.

The variation in switching characteristics of the switching devices from switching stage to switching stage in the FIG. 3 embodiment may be provided, for example, by adjusting width and length parameters of the switching devices. It will be assumed that within a given stage each of the switching devices has the same width (W) value and the same length (L) value, but that these parameters may vary from stage to stage. The device widths are denoted W1, W2, W3, W4 and W5, and the device lengths are denoted L1, L2, L3, L4 and L5, for the switching devices M1<x>, M2<x>, M3<x>, M4<x> and M5<x>, respectively, where x takes on integer values from 1 up to m, k, n, i or j for M1, M2, M3, M4 and M5.

The on resistance of each of the stages 300 is based on the parallel combination of the on resistances of the respective parallel-connected switching devices of that stage. It is assumed that the switching devices are operating in a triode region after those devices are turned on and the vddi outputs settle. Similarly, the on resistance of the power switch 122-1 is given by the parallel combination of the on resistances of the five switching stages. Let Ron1, Ron2, Ron3, Ron4 and Ron5 denote the on resistances of Stage 1 to Stage 5, respectively. The total on resistance of the power switch 122-1 is therefore given by:

Ron=Ron1∥Ron2∥Ron3∥Ron4∥Ron5 (1)

In the present embodiment, Stage 3 is an intermediate stage designed to reduce the voltage drop, also referred to as the IR drop, across the power switch 122-1 when in its on state and under maximum dynamic current load conditions. As noted previously, the on resistances of the switching devices are reduced from switching stage to switching stage in the initial switching stages 300-1 and 300-2 that are used to control the rate of change of power supply current when the power switch is transitioning from the off state to the on state, and the on resistances of the switching devices are increased from switching stage to switching stage in the final switching stages 300-4 and 300-5 that are used to control a rate of change of power supply current when the power switch is transitioning from the on state to the off state. This on resistance relationship at the switching stage level may be expressed in the following manner

Ron1>Ron2>>Ron3<<Ron4<Ron5 (2)

The on resistance of Stage 3 is given by:

$$Ron 3 = \frac{1}{n} * \frac{L 3}{β * W 3 * ( vdd - \vert Vth 3 \vert )} \qquad ( 3 )$$

where n is the number of switching devices in Stage 3, and W3, L3 and Vth3 denote the width, length and threshold voltage, respectively, of each M3<x> switching device in Stage 3, and β is a PMOS transconductance term that is assumed to be a constant in a given process and may be computed as a product of carrier mobility and gate oxide capacitance per unit area. The voltage drop across the power switch 122-1 is denoted Vdrop and may be expressed as a function of load current I_{load} in the following manner:

$$Vdrop = Ron * {I}_{load} < Ron 3 * {I}_{load} = {I}_{load} * \frac{1}{n} * \frac{L 3}{β * W 3 * ( vdd - \vert Vth 3 \vert )} \qquad ( 4 )$$

Accordingly, the voltage drop across the power switch in its on state under maximum load conditions is controlled by selecting appropriate values for n, W3 and L3 for the switching devices M3<x> of Stage 3.

As mentioned above, Stage 1 and Stage 2 are designed to control the inrush current when the power switch 122-1 transitions from its off state to its on state. The resistor-capacitor values R1-C1 and R2-C2 in these two stages are selected to control the delay time associated with turning on each switching device. Let T_{d1} be the delay time when turning on each switching device in Stage 1 and T_{d2} be the delay time when turning on each switching device in Stage 2. Vth1 and Vth2 denote the threshold voltages of the M1<x> and M2<x> switching devices, respectively.

When vddi<|Vth1|, the switching devices of Stage 1 are turned on and in a saturation region of operation. The inrush current Irush_sat in the saturation region may then be given by Equation (5) below, and the associated rate of change of the inrush current Irush_sat given by Equation (6):

$$\begin{matrix}Irush\_sat ( t ) \approx β * \frac{t}{{T}_{d 1}} * \frac{W 1}{L 1} * {\vert Vgs - Vth 1 \vert}^{2} = β * \frac{t}{{T}_{d 1}} * \frac{W 1}{L 1} * {( vdd - \vert Vth 1 \vert )}^{2} & ( 5 ) \\ ⇒ \frac{d Irush\_sat ( t )}{d t} \approx β * \frac{1}{{T}_{d 1}} * \frac{W 1}{L 1} * {( vdd - \vert Vth 1 \vert )}^{2} & ( 6 )\end{matrix}$$

When vddi≧|Vth1|, the switching devices of Stage 1 remain turned on but exit the saturation region of operation and enter the triode region of operation. The inrush current Irush_tri in the triode region and the associated rate of change of the inrush current Irush_tri may then be expressed as shown in Equations (7) through (9) below:

$$\begin{matrix}Irush\_tri ( t ) \approx β * \frac{t}{{T}_{d 1}} * \frac{W 1}{L 1} * [ ( vdd - \vert Vth 1 \vert ) * ( vdd - vddi ( t ) ) - \frac{1}{2} * {( vdd - vddi ( t ) )}^{2} ] & ( 7 ) \\ ⇒ \frac{d Irush\_tri ( t )}{d t} \approx β * \frac{1}{{T}_{d 1}} * \frac{W 1}{L 1} * [ ( vdd - \vert Vth 1 \vert ) * ( vdd - vddi ( t ) ) - \frac{1}{2} * {( vdd - vddi ( t ) )}^{2} ] + β * \frac{t}{{T}_{d 1}} * \frac{W 1}{L 1} * [ - ( vdd - Vth 1 ) * \frac{d vddi ( t )}{d t} + ( vdd - vdd ( t ) ) * \frac{d vdd ( i )}{d t} ] \approx β * \frac{1}{{T}_{d 1}} * \frac{W 1}{L 1} * [ ( vdd - \vert Vth 1 \vert ) * ( vdd - vddi ( t ) ) - \frac{1}{2} * {( vdd - vddi ( t ) )}^{2} ] - β * \frac{t}{{T}_{d 1}} * \frac{W 1}{L 1} * ( vddi ( t ) - Vth 1 ) * \frac{d vddi ( t )}{d t} & ( 8 ) \\ ⇒ \frac{d Irush\_tri ( t )}{d t} \leq β * \frac{1}{{T}_{d 1}} * \frac{W 1}{L 1} * [ ( vdd - \vert Vth 1 \vert ) * ( vdd - vddi ( t ) ) - \frac{1}{2} * {( vdd - vddi ( t ) )}^{2} ] \leq \frac{d Irush\_sat ( t )}{d t} & ( 9 )\end{matrix}$$

It is apparent from Equations (6) and (9) that the maximum rising slope of the inrush current in power switch 122-1 occurs when the switching devices of Stage 1 are turned on and operating in the saturation region. In the present embodiment, parameters W1, L1, R1 and C1 in Stage 1 are selected to control this maximum rising slope of the inrush current.

The static leakage current Iₗₑₐₖ of the circuit core 124-1 can be large, particularly when using deep sub-micron processes such as a 40 nm process. However, Iₗₑₐₖ is still much smaller than the dynamic load current I_{load} when the power switch is in its on state under maximum load current conditions. When the power switch is first turned on, most of the circuitry in the circuit core 124-1 is still in a static mode and therefore the static leakage current Iₗₑₐₖ is still present. Therefore, when Stage 1 is initially turned on at time t=t1, vddi can be made close to vdd by selecting a large value for m as shown in Equation (10):

$$vddi ( t 1 ) = vdd - \frac{1}{m} * \frac{L 1}{β * W 1 * ( vdd - \vert Vth 1 \vert )} * {I}_{leak} \qquad ( 10 )$$

In this embodiment, the W3 parameter of each M3<x> switching device in Stage 3 is set much larger than the corresponding W1 parameter of each M1<x> switching device in Stage 1 and the corresponding W2 parameter of each M2<x> switching device in Stage 2. After Stage 1 and Stage 2 are turned on, vddi is greater than |Vth3|. Before turning on Stage 3, vddi should be close to vdd. Otherwise there will be a large peak current in the M3<1> switching device during the turn on transition of Stage 3. This peak current Irush in the M3<1> switching device can be reduced by increasing vddi as per Equation (11) below:

$$Irush \approx β * \frac{W 3}{L 3} * [ ( vdd - \vert Vth 3 \vert ) * ( vdd - vddi ) - \frac{1}{2} * {( vdd - vddi )}^{2} ] \qquad ( 11 )$$

Stage 2 in this embodiment may be configured so as to allow the number m of switching devices in Stage 1 to be reduced in order to save circuit area. More particularly, in a manner consistent with Equation (2), the W2 parameter of the switching devices M2<x> of Stage 2 is bigger than the W1 parameter of the switching devices M1<x> in Stage 1 but smaller than the W3 parameter of the switching devices M3<x> in Stage 3.

When the power switch 122-1 is turned off, an increasing amount of load current is concentrated on the last switching devices. Accordingly, Stage 5 is configured with a large on resistance in order to reduce the power supply current during turn off. Stage 4 may be configured so as to allow the number j of switching devices in Stage 5 to be reduced in order to save circuit area. More particularly, in a manner consistent with Equation (2), the W4 parameter of the switching devices M4<x> of Stage 4 is bigger than the W5 parameter of the switching devices M5<x> in Stage 5 but smaller than the W3 parameter of the switching devices M3<x> in Stage 3.

The turn off process is otherwise substantially the inverse of the turning on process previously described. The power switch 122-1 is therefore configured to not only control the inrush current when turning the power switch on, but also the rate of change of the current when turning the power switch off. This helps to alleviate voltage disturbances that can adversely impact the operation of other circuit cores.

As a more detailed example of one possible embodiment of the power switch 122-1 of FIG. 3, the parameters of the switch may be set as shown in TABLE 1 below. In this embodiment, it is assumed that the power switch is implemented in an SOC that is manufactured using a 40 nm CMOS process. The switching device sizes are given in terms of width and length in micrometers (um).

TABLE 1
Parameter settings for power switch in 40 nm process SOC

| | | | | | |
|---|---|---|---|---|---|
| parameter | m | k | n | i | J |
| Value | 80 | 40 | 1400 | 40 | 20 |
| parameter | R1 | R2 | R3 | R4 | |
| Value | 20 Kohm | 19 Kohm | 19 Kohm | 20 Kohm | |
| parameter | C1 | C2 | C3 | C4 | |
| Value | 150 fF | 100 fF | 100 fF | 150 fF | |
| parameter | W1 | W2 | W3 | W4 | W5 |
| Value | 122.88 um | 244.72 um | 428.26 um | 244.72 um | 184.32 um |
| parameter | L1 | L2 | L3 | L4 | L5 |
| Value | 0.2 um | 0.1 um | 0.06 um | 0.1 um | 0.2 um |

In this example, the leakage current Iₗₑₐₖ is about 712 mA at a temperature of 125° C., and at a load current I_{load} of 2.5 A, the voltage drop across the power switch is less 10 mV. Also, the voltage disturbances on the power supply lines of the SOC are all less than 50 mV.

Accordingly, this embodiment provides low leakage current in an SOC manufactured using a deep sub-micron process, while also controlling power up and power down transient currents as well as power supply line voltage disturbances. This is achieved while maintaining a low voltage drop even in the presence of a large dynamic operating current. Moreover, the power switch avoids the need for separate isolated power islands in the SOC, and therefore conserves circuit area.

It is to be appreciated that the particular parameters shown in TABLE 1 above are presented by way of illustrative example only, and a wide variety of other combinations of parameters may be used in other embodiments of the invention.

It should also be understood that the particular power switch circuitry arrangement shown in FIG. 3 is presented by way of example only, and other embodiments of the invention may utilize other types of circuitry to implement the described functionality.

For example, in the FIG. 3 embodiment, the two initial switching stages 300-1 and 300-2 are used to control the power on transient current and the two final switching stages 300-4 and 300-5 are used to control the power off transient current. However, in other embodiments, one or more of the two initial switching stages with embedded RC circuitry can each be separated into more than two stages, each with different RC values, in order to obtain a more smooth power up transient current. Also, in these split stages, the on resistances of the switching devices can be reduced smoothly stage by stage. In a similar manner, one or more of the two final switching stages with embedded RC circuitry can each be separated into more than two stages, each with different RC values, in order to obtain a more smooth power down transient current. Also, in these split stages, the on resistances of the switching devices can be increased smoothly stage by stage. In these arrangements, the power switch 122-1 may comprise more than five switching stages, such as seven or more switching stages.

As indicated previously, power switches 122 can be implemented in a wide variety of different types of data processing systems. Another embodiment of such a system is the data processing system 400 shown in FIG. 4. This system comprises an HDD 402 coupled to a host device 404. The HDD 402 comprises an SOC integrated circuit 405 comprising a disk controller 406 coupled to read channel circuitry 408. The disk controller 406 and read channel circuitry 408 represent distinct circuit cores of the SOC 405 that can be independently turned on and off using respective control signals.

The SOC 405 communicates via a preamplifier 410 with a read/write head 412 in order to write data to and read data from one or more storage disks 414. The read channel circuitry 408 includes a digital signal processor (DSP) 415 that comprises conventional signal processing components typically associated with an HDD read channel.

The host device 404 may comprise, for example, a computer or other processing device that is coupled to or incorporates the HDD 402. Such a processing device may comprise processor and memory elements used to execute software code. The SOC 405 may also comprise processor and memory elements used to execute software code. The software code stored in a memory of system 400 may be used for generating control signals or otherwise controlling operation of power supply circuitry of the SOC 405.

A given such memory that stores software code for execution by a corresponding processor is an example of what is more generally referred to herein as a computer-readable medium or other type of computer program product having computer program code embodied therein, and may comprise, for example, electronic memory such as RAM or ROM, magnetic memory, optical memory, or other types of storage devices in any combination.

The processor may comprise a microprocessor, CPU, ASIC, FPGA or other type of processing device, as well as portions or combinations of such devices. Although not expressly shown in FIG. 4, such a processor may be implemented in the SOC 405, or in another part of the HDD 402.

The SOC 405 further comprises power switches 422-1 and 422-2 which are configured to control application of power supply voltage vdd to vddi inputs of the respective disk controller 406 and read channel circuitry 408, responsive to the above-noted control signals, which are denoted V_{IN1} and V_{IN2}, respectively.

An example of an SOC integrated circuit that may be modified for use in embodiments of the invention is disclosed in U.S. Pat. No. 7,872,825, entitled “Data Storage Drive with Reduced Power Consumption,” which is commonly assigned herewith and incorporated by reference herein.

Other types of integrated circuits that may be used to implement processor, memory or other system components of a given embodiment include, for example, a microprocessor, ASIC, FPGA or other integrated circuit device.

In an integrated circuit implementation of an embodiment of the invention, multiple integrated circuit dies may be formed in a repeated pattern on a surface of a wafer. Each such die may include one or more power switches as described herein, and may include other structures or circuits. The dies are cut or diced from the wafer, then packaged as integrated circuits. One skilled in the art would know how to dice wafers and package dies to produce packaged integrated circuits. Integrated circuits so manufactured are considered embodiments of this invention.

Multiple instances of the HDD 402 of FIG. 4 may be incorporated into a virtual storage system. Such a virtual storage system, also referred to as a storage virtualization system, may illustratively comprise a virtual storage controller coupled to a RAID system, where RAID denotes Redundant Array of Independent Disks. The RAID system more specifically comprises a plurality of distinct storage devices, one or more of which are assumed to be configured to include power supply circuitry 120 comprising at least one power switch 122 as disclosed herein. These and other virtual storage systems comprising HDDs or other disk-based storage devices are considered embodiments of the invention. The host processing device 404 in FIG. 4 may also be an element of a virtual storage system, and may incorporate the above-noted virtual storage controller.

As indicated previously, the power switch 122-1 as shown in the FIG. 3 embodiment utilizes PMOS transistors to control application of a supply voltage to a circuit core, but other embodiments may utilize n-type MOS (NMOS) transistors, or more generally other types of switching devices, to control application of a supply voltage to a circuit core. For example, the PMOS transistors of FIG. 3 may be replaced with NMOS transistors in the manner illustrated in FIG. 5. In this embodiment, a first switching device 500 and a corresponding pair of series-connected inverters 502-1 and 502-2 of power switch 122-1 are shown. The first switching device 500 is an NMOS transistor with its source terminal coupled to ground potential and its drain terminal coupled to a supply input of a circuit core 504. The control signal VIN1 is applied to an input of the first inverter 502-1 and the output of the second inverter 502-2 drives the gate terminal of the NMOS switching device 500. The circuit core 504 is modeled as a parallel combination of a load resistor R_{L} and a load capacitance C_{L}.

In this context, it should be noted that a given source or drain terminal of a PMOS or NMOS transistor may be more generally referred to herein as a source/drain terminal. Numerous other configurations of circuitry may be used for implementing a power switch in other embodiments. Also, ground potential may be considered to be a type of supply input or power supply terminal of a circuit core.

Again, it should be emphasized that the embodiments of the invention as described herein are intended to be illustrative only. For example, other embodiments of the invention can be implemented using a wide variety of other types of power supply circuitry and associated power switches, with different arrangements of switching stages, switching devices, control signals and switching characteristics, than those included in the embodiments described herein. These and numerous other embodiments within the scope of the following claims will be readily apparent to those skilled in the art.

What is claimed is:

1. An apparatus comprising:
a power switch comprising a plurality of series-connected switching stages, each such series-connected switching stage comprising a plurality of parallel-connected switching devices and an inverter chain, the switching devices being coupled between a power supply input and a power supply output of the power switch, and each of the switching devices of a given one of the switching stages being driven by an output of a corresponding one of the inverters of the inverter chain of that switching stage;
wherein a control input of a first one of the switching stages is adapted to receive a control signal for controlling a state of the power switch;
wherein a control input of each of the remaining switching stages is driven by a control output of an immediately preceding one of the switching stages; and
wherein the parallel-connected switching devices in one or more of the switching stages are configured to have different switching characteristics than the parallel-connected switching devices in at least one other one of the switching stages.

2. The apparatus of claim 1 wherein one or more initial switching stages of the plurality of switching stages are configured to control a rate of change of power supply current when the power switch is transitioning from an off state to an on state and one or more final switching stages of the plurality of switching stages are configured to control the rate of change of power supply current when the power switch is transitioning from the on state to the off state.

3. The apparatus of claim 1 wherein the parallel-connected switching devices in at least a given one of the switching stages comprise respective metal-oxide-semiconductor transistors each having a first source/drain terminal coupled to the power supply input of the power switch, a second source/drain terminal coupled to the power supply output of the power switch, and a gate terminal coupled to the output of the corresponding one of the inverters of the inverter chain of the given switching stage.

4. The apparatus of claim 1 wherein the inverter chain in at least a given one of the switching stages comprises a separate set of at least first and second series-connected inverters for each of the switching devices of the given switching stage, with an output of the second inverter being coupled to a control terminal of a corresponding one of the switching devices of the given switching stage.

5. The apparatus of claim 4 wherein the given switching stage further comprises resistor-capacitor circuits coupled between the first and second series-connected inverters in respective ones of the sets of inverters.

6. The apparatus of claim 5 wherein the given switching stage comprising the resistor-capacitor circuits coupled between the first and second inverters in respective ones of the sets of inverters is one of the first switching stage and a final one of the switching stages.

7. The apparatus of claim 6 wherein the plurality of series-connected switching stages comprises at least three switching stages, with each of the first switching stage and a final one of the switching stages comprising resistor-capacitor circuits coupled between the first and second inverters in respective ones of the sets of inverters of that switching stage.

8. The apparatus of claim 7 wherein the plurality of series-connected switching stages comprises at least five switching stages, with each of at least two initial switching stages and at least two final switching stages comprising resistor-capacitor circuits coupled between the first and second inverters in respective ones of the sets of inverters of that switching stage.

9. The apparatus of claim 5 wherein a given one of the resistor-capacitor circuits comprises a resistor connected in series between an output of the first inverter and an input of the second inverter and a capacitor connected between the input of the second inverter and a lower supply potential.

10. The apparatus of claim 2 wherein the switching characteristic of the switching devices comprises an on resistance of the switching devices, with a plurality of initial switching stages of the plurality of switching stages being configured to control a rate of change of power supply current when the power switch is transitioning from an off state to an on state, and further wherein the on resistance of the switching devices is reduced from switching stage to switching stage in the plurality of initial switching stages, and with a plurality of final switching stages of the plurality of switching stages being configured to control a rate of change of power supply current when the power switch is transitioning from the on state to the off state, and further wherein the on resistance of the switching devices is increased from switching stage to switching stage in the plurality of final switching stages.

11. The apparatus of claim 1 wherein at least two of the switching stages comprise different numbers of parallel-connected switching devices.

12. The apparatus of claim 1 wherein one of the switching stages comprises at least 10 times more parallel-connected switching devices than one or more of the other switching stages.

13. The apparatus of claim 1 wherein the plurality of series-connected switching stages comprises at least five switching stages, with each of two initial switching stages and two final switching stages comprising substantially fewer parallel-connected switching devices than one or more remaining switching stages between the initial and final switching stages, the one or more remaining switching stages having a substantially lower on resistance than the initial and final switching stages.

14. The apparatus of claim 13 wherein the initial and final switching stages each comprise less than 100 parallel-connected switching devices and at least one of the remaining switching stages between the initial and final switching stages comprises more than 1000 parallel-connected switching devices.

15. An integrated circuit comprising the apparatus of claim 1.

16. The integrated circuit of claim 15 wherein said integrated circuit comprises a plurality of circuit cores with said power switch controlling application of power to a particular one of those circuit cores.

17. A method comprising the steps of:
configuring a power switch comprising a plurality of series-connected switching stages, each such series-connected switching stage comprising a plurality of parallel-connected switching devices and an inverter chain, the switching devices being coupled between a power supply input and a power supply output of the power switch, and each of the switching devices of a given one of the switching stages being driven by an output of a corresponding one of the inverters of the inverter chain of that switching stage; and
controlling a state of the power switch responsive to a control signal applied to a control input of a first one of the switching stages;
wherein a control input of each of the remaining switching stages is driven by a control output of an immediately preceding one of the switching stages; and
wherein the parallel-connected switching devices in one or more of the switching stages are configured to have different switching characteristics than the parallel-connected switching devices in at least one other one of the switching stages.

18. The method of claim 17 wherein the configuring step further comprises:
configuring one or more initial switching stages of the plurality of switching stages to control a rate of change of power supply current when the power switch is transitioning from an off state to an on state; and
configuring one or more final switching stages of the plurality of switching stages to control the rate of change of power supply current when the power switch is transitioning from the on state to the off state.

19. A processing device comprising:
an integrated circuit comprising a plurality of circuit cores; and
power supply circuitry for supplying power to said circuit cores;
the power supply circuitry comprising a plurality of power switches with each said power switch controlling application of power to a corresponding one of said circuit cores;
a given one of the power switches comprising a plurality of series-connected switching stages, each such series-connected switching stage comprising a plurality of parallel-connected switching devices and an inverter chain, the switching devices being coupled between a power supply input and a power supply output of the power switch, and each of the switching devices of a given one of the switching stages being driven by an output of a corresponding one of the inverters of the inverter chain of that switching stage;
wherein a control input of a first one of the switching stages is adapted to receive a control signal for controlling a state of the power switch;
wherein a control input of each of the remaining switching stages is driven by a control output of an immediately preceding one of the switching stages; and
wherein the parallel-connected switching devices in one or more of the switching stages are configured to have different switching characteristics than the parallel-connected switching devices in at least one other one of the switching stages.

20. The processing device of claim 19 wherein the processing device further comprises a storage device and the integrated circuit comprises a system-on-chip integrated circuit comprising disk controller and read channel cores.
